(19) United States
(12) Patent Application Publication
(10) Pub. No.: US 2014/0365873 A1
(43) Pub. Date: Dec. 11, 2014

(54) COMPUTING DEVICES FOR GENERATING CONTENT LAYOUT

(71) Applicant: Hewlett-Packard Development Company, L.P., Fort Collins, CO (US)

(72) Inventors: Christopher Willis, Palo Alto, CA (US); Kevin Smathers, Palo Alto, CA (US)

(21) Appl. No.: 13/913,791

(22) Filed: Jun. 10, 2013

(51) Int. Cl. G06F 17/21

(52) U.S. Cl. CPC G06F 17/212
USPC 715/243

(57) ABSTRACT

Examples disclosed herein relate to arranging content displayed on a display of a computing device. The computing device receives a content change to alter one or more items displayed on the computing device. The computing device generates a content layout responsive to the content change, wherein positioning of remaining items displayed on the computing device remains the same with respect to positioning of the one or more items. The computing device displays the content layout on the computing device.

### BACKGROUND

There is a need for displaying multiple sources of content at a particular time on a display. The need varies, for example, for monitoring and control, collaboration, and sales and presentation needs. Having the ability to view multiples sources of content at the same time allows people to make informed decisions and perform tasks efficiently.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1A illustrates a block diagram of a display and computing devices, according to one example;

FIG. 1B illustrates a block diagram of computing devices connected to each other via interconnections, according to one example;

FIG. 2 is a flowchart of a method performed by a computing device, according to one example;

FIGS. 3A-C illustrate a series of block diagrams with content layout illustrated on a display of a computing device, according to one example;

FIGS. 4A-G illustrate a series of block diagrams with content layout illustrated on at least two computing devices and a common display, according to one example; and

FIG. 5 is a block diagram of a non-transitory machine-readable storage medium encoded with instructions for updating content layout of a display, according to one example.

### DETAILED DESCRIPTION

Various aspects of the present disclosure are directed to techniques for arranging content illustrated on a display that has been rearranged or changed, so that the content fits within the screen boundaries of the display.

Collaborative environments include members of a team working together by sharing ideas, information, and work with each other in an effort to complete a task. The members may be working together in a physical location or spread out over geographical distances. In an effort to collaborate with each other, the members may view the shared information via a common display, for example, a large display in a conference room. Multiple sources of information from the members may be viewable at a particular time via the common display. For the members spread out over geographical distances, they may view what is displayed on the common display via a computing device, such as a desktop workstation, laptop, tablet, or smartphone, and also share information that is viewable by others, including the members viewing the common display. By being able to view multiple sources of information at a particular time, members may bring to the attention of the other members all the information that is relevant for completing the task. In addition to collaborative environments, the ability to display multiple sources of content at a particular time could be useful in situations such as control room scenarios, and for sales and presentation needs.

While viewing multiple sources of information at a particular time, it is desirable to have the ability to rearrange the content as displayed or add new content. A solution for displaying multiple sources of content on a display, such as those found in control rooms, have been to write software code to control how the different sources of content are arranged on the display. To rearrange the content as displayed or adding new content may require a change to the software code to accommodate the content change. Another solution for displaying multiple sources of content on a display includes manually arranging content displayed on the display using input devices such as a keyboard or mouse.

Examples disclosed herein utilize a layout solver for automatically arranging content displayed on a display that has been rearranged or changed, so that all the content fits within the screen boundaries of the display. Ensuring that the content is properly arranged and fits within the boundaries of the display allows a team to bring together diverse sources of content into a live, interactive, coordinated, controllable, and unified display.

It is appreciated that examples described herein below may include various components and features. It is also appreciated that, in the following description, numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example. As used herein, a component is a combination of hardware and software executing on that hardware to provide a given functionality.

As used herein, a “layout solver” refers to instructions included in the memory of a computing device for managing the location, size, and scale of each piece of content displayed on a display associated with the computing device, and constructing a layout model that references how the content are arranged relative to one another in rows and columns. The instructions are executable by a processor of the computing device.

In one example, a method performed by a computing device is provided. The method includes receiving a content change to alter one or more items displayed on the computing device. The method includes generating a content layout responsive to the content change, wherein positioning of remaining items displayed on the computing device remains the same with respect to positioning of the one or more items. The method also includes displaying the content layout on the computing device.

In another example, a computing device includes a display for displaying content from computing devices connected to one another via a network. The computing device includes a processor and a memory storing instructions executable by the processor. The instructions are executable to receive a content change to alter one or more items displayed on the display. The instructions are executable to generate a content layout responsive to the content change, wherein positioning of remaining items displayed on the display remains the same with respect to positioning of the one or more items. The instructions are executable to also display the content layout on the display.

In another example, a non-transitory computer-readable storage medium includes instructions that, when executed by a processor of a computing device, cause the computing device to receive a content change to alter one or more items displayed on the computing device. The instructions are executable to generate a content layout responsive to the content change, wherein positioning of remaining items displayed on the computing device remains the same with respect to positioning of the one or more items. The instructions are executable to also display the content layout on the computing device.

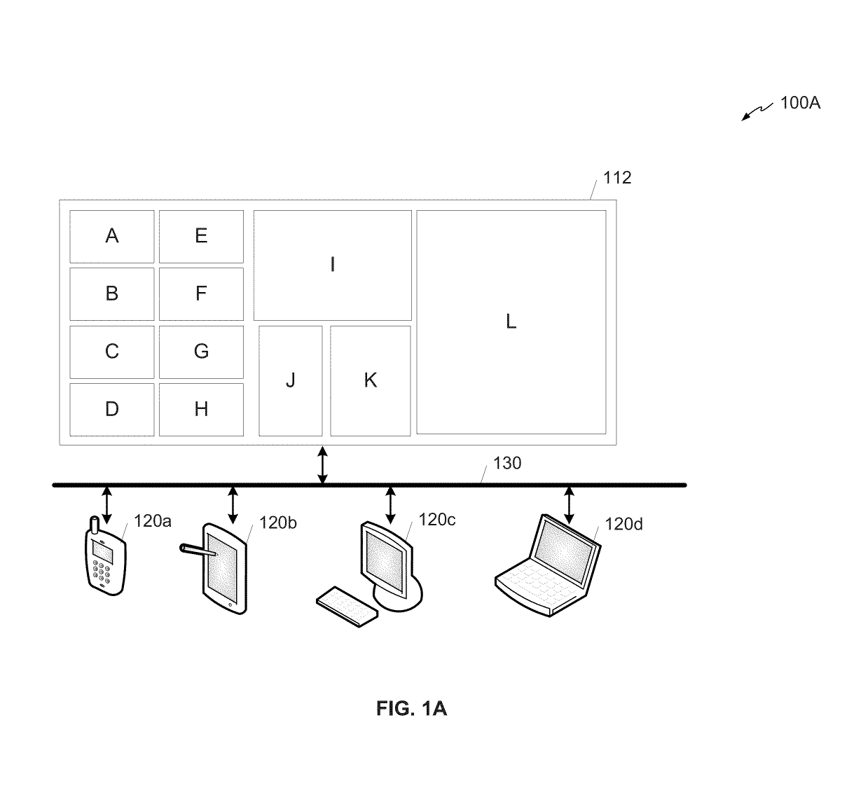

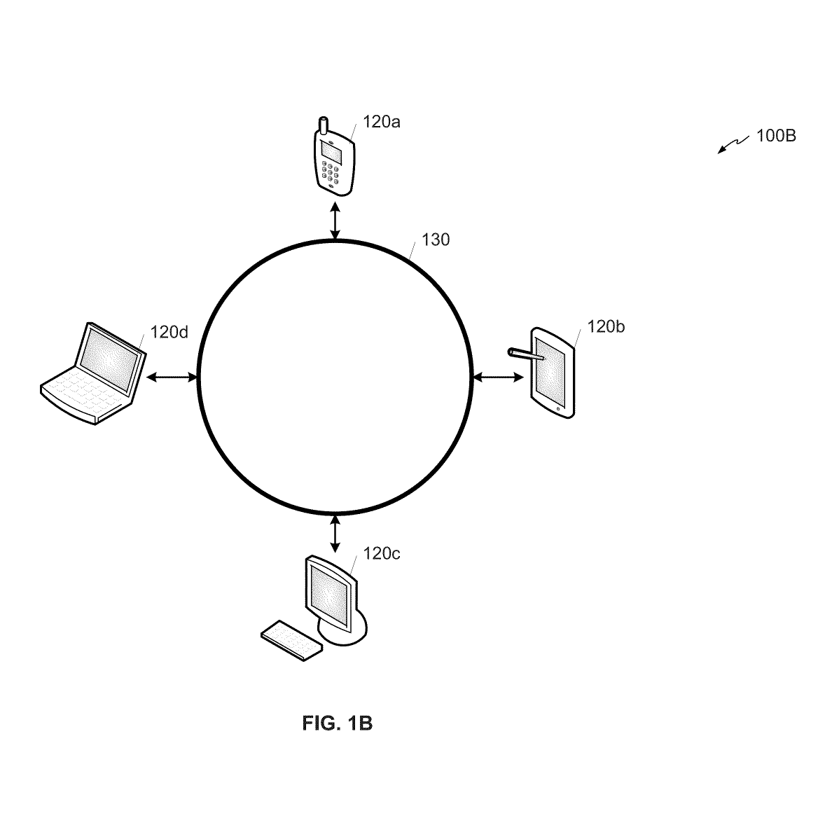

FIG. 1A illustrates a block diagram 100A of a display 112 and computing devices 120, according to one example. The display 112 may be connected to the video output of one of the computing devices 120 and viewable by an audience during a presentation or by a team in a conference room. The displays of the remaining computing devices 120 display content similar to what is displayed on the display 112. The computing devices 120 may communicate with each other using a set of interconnections 130. The interconnections 130 represent generally any infrastructure or combination of infrastructures configured to enable electronic communication between the computing devices 120. For example, the interconnections 130 may represent the Internet, one or more intranets, and any intermediate routers, switches, and other interfaces.

The computing devices 120 represent generally any computing device with which a user may interact to communicate with other computing devices via interconnections 130. The computing devices 120 include any number of computing devices, such as desktop workstations 120c, laptops 120d, tablets 120b, and smartphones 120a. The location of the computing devices 120 may vary, such as in the same room as the display 112 or in another location. The computing devices 120 include at least a display, memory, and a processor. The memory of a computing device 120 may store a plurality of instructions that may be executed by the processor. The memory may also store applications that are executable by the processor. Thus, the processor may execute instructions to carry out the functionality of the computing device 120.

The content illustrated, on the display 112 (e.g., contents A-L) are stored on one or more of the computing devices 120 or other computing devices connected to the network via interconnections 130. For example, content A-H may come from desktop workstation 120c and content I-L, may come from laptop 120d. Examples of such content include, but are not limited, to, Web content, ActiveX-based content, images, videos (streamed or stored), remote desktop logins, and productivity software documents.

Content illustrated on the display 112 may be arranged by a user in a particular way by using background elements known as containers. The content associated with a particular container may be arranged by the user either horizontally or vertically. Referring to FIG. 1A, contents A-D may be arranged vertically in a first container and contents E-H may be arranged vertically in a second container (i.e., vertical containers). In addition to the content arranged within a container, the container may have additional containers within itself, known as nested containers. For example, contents J and K may be arranged horizontally in a third container, and the third container may be nested vertically in a fourth container with content I. In addition, content L may be arranged in a fifth container. Finally, containers 1-5 may be nested horizontally in a sixth container, which contains all the content illustrated on display 112. Although contents A-L as illustrated in FIG. 1A have been arranged by using six containers, the content may be arranged by using any assortment of containers.

The computing devices 120 may be used for changing or rearranging content illustrated on the display 112. Memory of at least one of the computing devices 120 includes instructions for detecting content changes and implementing a layout solver that manages the location, size, and scale of each piece of content displayed on the display 112 and computing devices 120, and constructs a layout model that references how the content are arranged relative to one another in rows and columns. The layout model aids in ensuring the geometric relationships of the content are retained when content is rearranged or changed. For example, if a user desires to swap content A with content F, the layout model is updated so that content A replaces the original position of F (beginning at row 2 in the second container) and content F replaces the original position of content A (beginning at row 1 in the first container).

Smartphone 120a and tablet 120b may be used for rearranging the content A-L or adding/replacing new content. Mobile devices, such as smartphone 120a and tablet 120b, may include a web-based application programming interface (API) for controlling the content that is illustrated on the display 112. As an example, the display on the mobile devices may illustrate, via the web-based API, similar content as illustrated on display 112. Therefore, when a user makes changes to the content via their mobile device, the change is reflected on both their mobile device and the display 112. As an example, commands are sent from the mobile device that reflect the changes made to the content by the user on the mobile device. For example, if the user of smartphone 120a swaps content A with content L, a command reflecting this swap is issued to a computing device 120 on the network designated to detect content changes, and the layout solver is utilized (if necessary) to ensure that all the content fits within the screen boundaries of the display 112. Examples of other drag and drop operations include adding new content and deleting certain content illustrated on the display 112. The specific command that is issued may be indicated by the drag and drop operation itself.

Although the entire display of devices such as the smartphone 120a and tablet 120b may be used to reflect what is illustrated on display 112, this may not be desirable for other devices such as the desktop workstation 120c or laptop 120d. Rather, a minimally intrusive interface may be provided for such devices, where users generally need to interact with their own device, but need to be able to rapidly share content. For example, the user of desktop workstation 120c may select a file from the desktop, or drag a URL from a web browser to be displayed on the display 112. The user may carry this out by dragging the file or URL to a specified area on the desktop, and a command will be issued which indicates that content is available for the display 112. The specific command that is issued may be customized based on the type of data provided as indicated by the file extension, or as indicated by the drag and drop operation itself.

FIG. 1B illustrates a block diagram 100B of computing devices 120 connected to each other via interconnections 130, according to one example. In some situations, it may not be necessary to have a display that is viewable by a group of people, such as display 112. For example, in a collaborative environment, rather than a team gathering in a conference room, the team may be spread out over geographical distances, where members of the team may be able to view similar content on their own computing devices 120 rather than a common display 112. At least one of the computing devices, such as desktop workstation 120c, may be designated as a computing device connected to the network via interconnections 130 to detect for content changes from the other computing devices 120. Upon detecting a content change, the desktop workstation 120c may process the change, and utilize the layout solver (if necessary) to ensure that all the content fits within the screen boundaries of the computing devices 120. For example, machine-readable storage medium of the desktop workstation 120c may include instructions for implementing the layout solver.

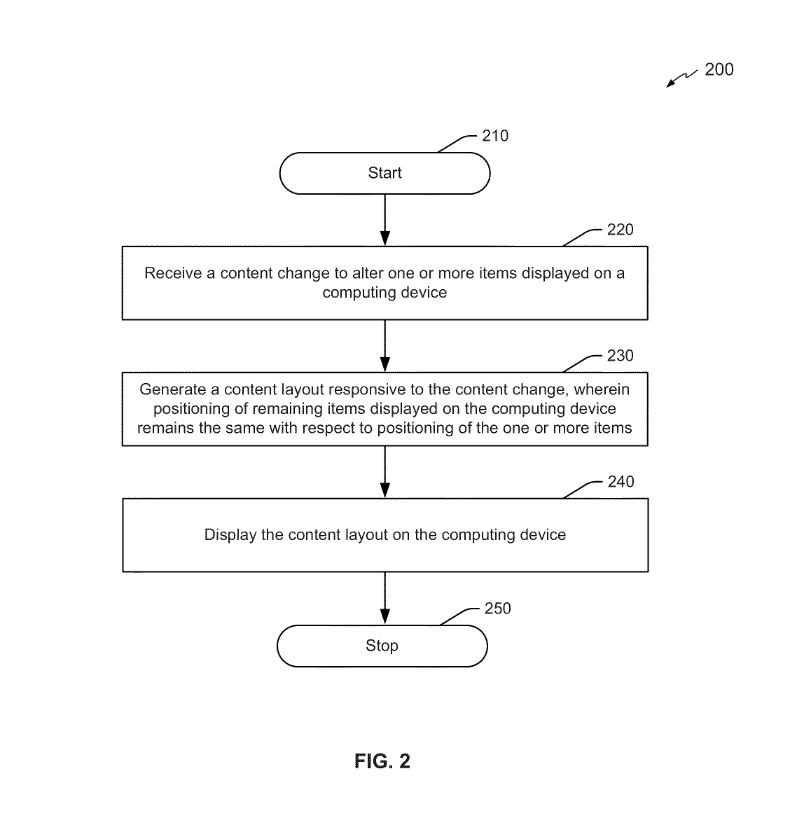

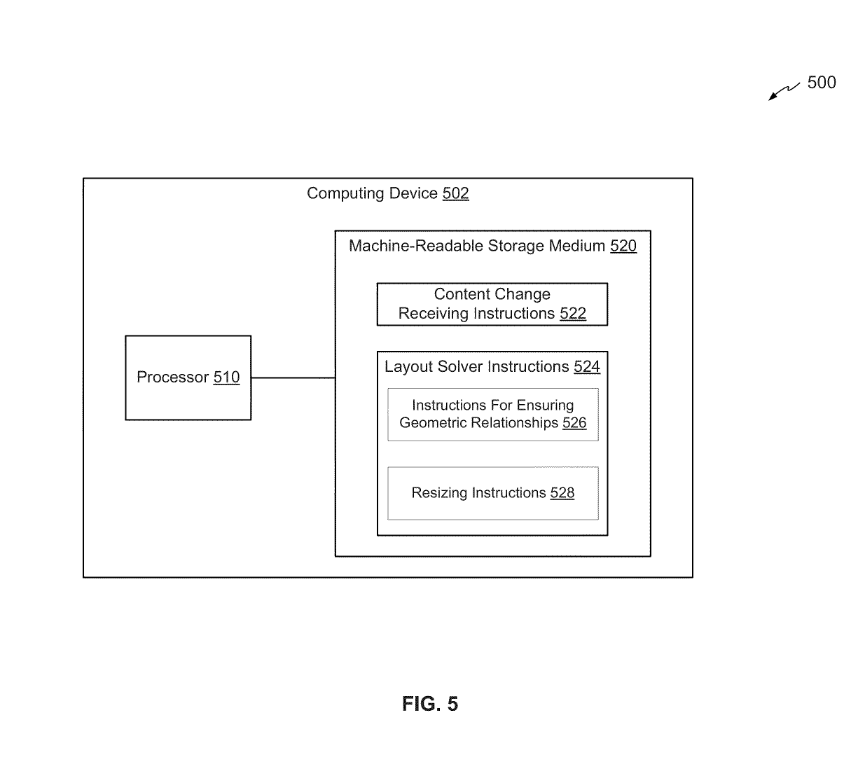

FIG. 2 is a flowchart of a method 200 performed by a computing device, such as the desktop workstation 120c, according to one example. Although method 200 is described below with reference to the components of FIGS. 1A and 1B, other suitable components for execution of method 200 will be apparent to those of skill in the art. Method 200 may be implemented in the form of executable instructions stored in a non-transitory machine-readable storage medium, such as machine-readable storage medium 520 of FIG. 5.

Method 200 may start in block 210 and proceed to block 220, where the desktop workstation 120c receives a content change to alter one or more items displayed on the desktop workstation 120c. For example, the user of tablet 120b may swap content A with content L. Upon dragging and dropping content A onto content L, the tablet 120b may send a command reflecting the content change performed by the user, and the processor of the desktop workstation 120c may receive the content change. Rather than receiving a content change from another computing device, such as tablet 120b, the desktop workstation 120c may receive a content change from a user of the desktop workstation 120c itself.

Method 200 may proceed to block 230, where the desktop workstation 120c generates a content layout responsive to the content change. The layout solver is used to generate the content layout by ensuring the geometric relationships of the content are retained and by resizing the elements (e.g., content A-L) so that no elements overlap or are moved off the display of any computing device 120 or display 112. Although the screen size of each computing device 120 may vary, the aspect ratio for a majority of devices is 16:9. Therefore, the layout solver may resize all of the elements so that the elements will fit within a 16:9 display.

The layout solver determines the aspect ratio of each element and then resizes the elements in an effort to retain its aspect ratio and fit all the elements within the display. However, it may not be necessary to resize every element illustrated on the display. For example, referring back to FIG. 1A, if content A is swapped with content I, only contents A and I may be resized, with the understanding that contents A and I have the same aspect ratio. Therefore, the size of content A may be increased and the size of content I may be decreased. As another example, if content A is swapped with content J, which have different aspect ratios, additional elements (e.g., contents A-L) may have to be resized in order to avoid overlap or any content from being moved off the display.

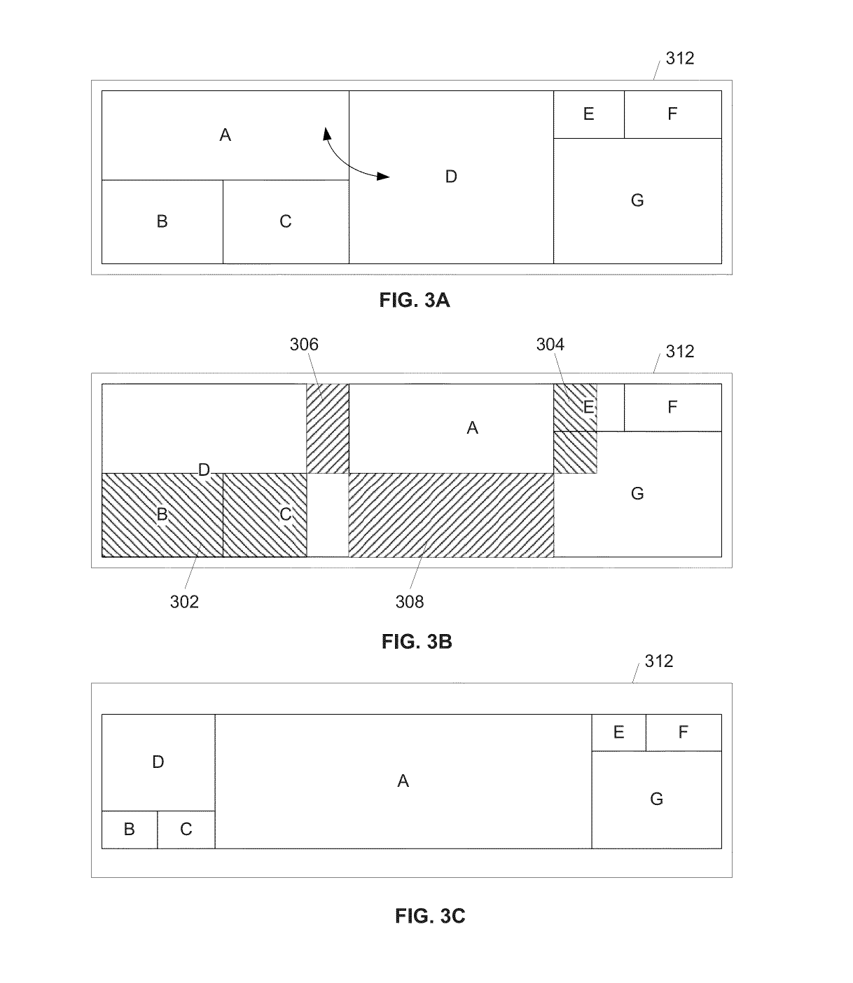

When resizing the elements, each element may be resized independently of the other elements, as will be illustrated in FIGS. 3A-C. Therefore, the size of certain elements may be increased and the size of other elements may be decreased and/or remain the same. The layout solver may include a recursive procedure, such as a recursive binary search, for resizing each element, until all the elements fit within the display. For example, for each element, the layout solver may perform a binary search to determine the best height to match a given width (or vice versa), applied recursively.

In addition to resizing the elements, the layout solver ensures that the geometric relationships of the elements are retained. In other words, referring back to FIG. 1A, after content A is swapped with content L, the layout model is updated so that content A replaces the original position of content L (in the fifth container) and content L replaces the original position of content A (beginning at row 1 in the first container). Therefore, content K remains to the left of content A and content E remains to the right of content L. By maintaining the general structure of the elements illustrated on the display and ensuring that the relative positioning of the elements remains the same when the content layout is generated, a user viewing the display of their computing device avoids having to remap where all the elements have been moved after a content change.

Method 200 may proceed to block 240, where the desktop workstation 120c displays the content layout on its display. As illustrated in FIG. 1B, multiple computing devices 120 may be involved, so the desktop workstation 120c may provide the content layout to the other computing devices 120 as well. Upon receiving the updated content layout, any of the other computing devices 120 may make another content change, from which the desktop workstation 120c may generate another content layout. This allows for a truly collaborative environment, where a user in one location may be able to change the content from their device, and a user in another location (or same location) would be able to see the updated content on their device, with all the content viewable on the display. Method 200 may then proceed to block 250, where the method 200 stops.

FIGS. 3A-C illustrate a series of block diagrams with content layout illustrated on a display 312 of a computing device, according to one example. Contents A-G may be arranged as illustrated by using containers. As an example, contents B and C may be arranged horizontally in a first container, and the first container may be nested vertically in a second container with content A. Content D may be arranged in a third container. Contents E and F may be arranged horizontally in a fourth container, and nested vertically in a fifth container with content G. Finally, containers 1-5 may be nested horizontally in a sixth container.

As illustrated in FIG. 3A, a user swaps content A with content D, which have different aspect ratios. The computing device generates a content layout responsive to the content change via the layout solver, the steps of which are illustrated in FIGS. 3B-C.

Referring to FIG. 3B, the layout solver ensures that the geometric relationships of the elements are retained. As an example, after content A is swapped with content D, the layout model is updated so that content A replaces the original position of content D (in the third container) and content D replaces the original position of content A (beginning at row 1 in the first container), as illustrated in FIG. 3B. After swapping contents A and D, content D overlaps content B and a portion of content C at 302, and content A overlaps portions of contents B and G at 304. In addition, there is a portion 306 of the second container and a portion 308 of the third container that is not occupied by any content, which may not be desirable. Therefore, certain elements may be resized so that content will occupy portions 306 and 308, and to avoid the overlapping of the content.

As an example of the steps taken by the layout solver to resize contents A-G, the layout solver first determines how much screen space is available for displaying the content on display 312. If the display 312 corresponds to the display of a mobile device, such as a smartphone or tablet, the entire display of the mobile device may be available for displaying contents A-G. However, if the display 312 corresponds to the display of a laptop or desktop workstation, only a portion of the display may be available for displaying contents A-G, as described above. Upon determining how much screen space is available, the layout solver determines the aspect ratio of the available display area.

Secondly, the layout solver determines the aspect ratio of each container, including the nested containers. If content is arranged in a container horizontally, then the aspect ratio of the container is the sum of the aspect ratios of the content. However, if content is arranged in a container vertically, then the aspect ratio of the container is the inverse of the sum of the inverse aspect ratios of the content. For a nested container within a container, the aspect ratio of the nested container is determined similarly as described above.

Referring to FIG. 3B, the layout solver determines the aspect ratio of the sixth container, which includes all the content illustrated on the display 312. However, since containers 1-5 are nested horizontally in the sixth container, the layout solver first determines the aspect ratios of containers 1-5 and then sums the aspect ratios of containers 1-5 to determine the aspect ratio of the sixth container. As an example of determining the aspect ratio of a container with content arranged vertically, reference is made to the second container, which includes contents B-D. Since the first container is nested within the second container, the aspect ratio of the first container is first determined by taking the sum of the aspect ratios of contents B and C. After determining the aspect ratio of the first container, the aspect ratio of the second container is determined by taking the inverse of the sum of the inverse aspect ratios of content D and the first container. In an effort to account for the unused portion 306 of the second container and the overlap 302, the aspect ratio of the second container is changed to accommodate the aspect ratio of newly added content D. Similarly, in an effort to account for the unused portion 308 of the third container and overlap 304, the aspect ratio of the third container is changed to accommodate the aspect ratio of newly added content A.

Thirdly, once the aspect ratio of the sixth container is determined, the layout solver scales the sixth container to fill the available display area of the display 312. If the aspect ratio of the sixth container is greater than the aspect ratio of the available display area, then the width of the sixth container is set to the width of the display area, and the height of the sixth container is set the width of available display area divided by the aspect ratio of the sixth container. If the aspect ratio of the sixth container is less than the aspect ratio of the available display area, then the height of the sixth container is set to the height of the available display area, and the width of the sixth container is set to the height of the available display area multiplied by the aspect ratio of the sixth container.

Finally, upon determining the width and height of the sixth container, the layout solver proceeds by placing each nested element (e.g., contents A-G within containers 1-5) within the previously calculated display space. Starting with the first nested container and proceeding one at a time, the width and height of each element is determined by its aspect ratio. As a result, contents A-G are resized to avoid overlap and fit within the display 312 of the computing device, as illustrated in FIG. 3C. As mentioned earlier, when resizing the elements, each element may be resized independently of the other element, where the size of certain elements may be increased and the size of other elements may be decreased and/or remain the same. In an effort to avoid the overlap 304 and account for the unused portion 308 of the display 312, the size of content A may be increased. By increasing the size of content A, in accordance with its aspect ratio, the size of contents B-D may be reduced. However, the factor by which the size of contents B-C is reduced may be different from the factor by which the size of content D is reduced, in an effort to match the width of contents B and C with the width of content D. Therefore, contents A-G no longer overlap and are now all viewable within the display 312. The steps taken by a layout solver to resize content illustrated on a display is not limited to the steps described above.

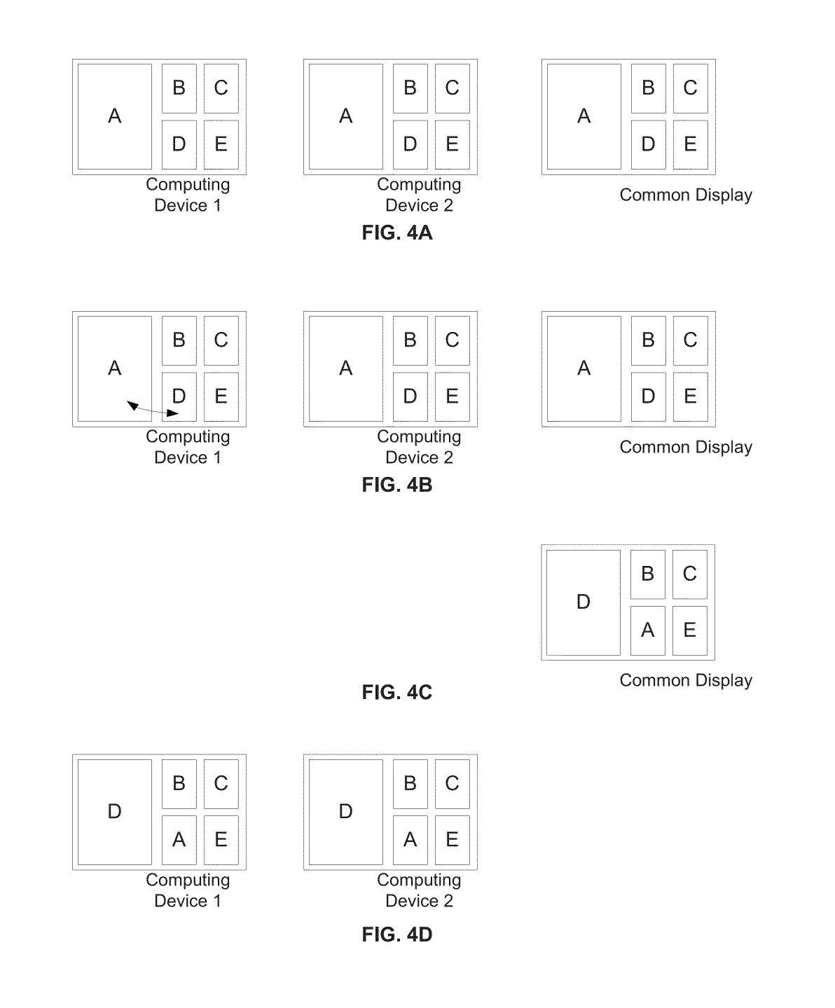

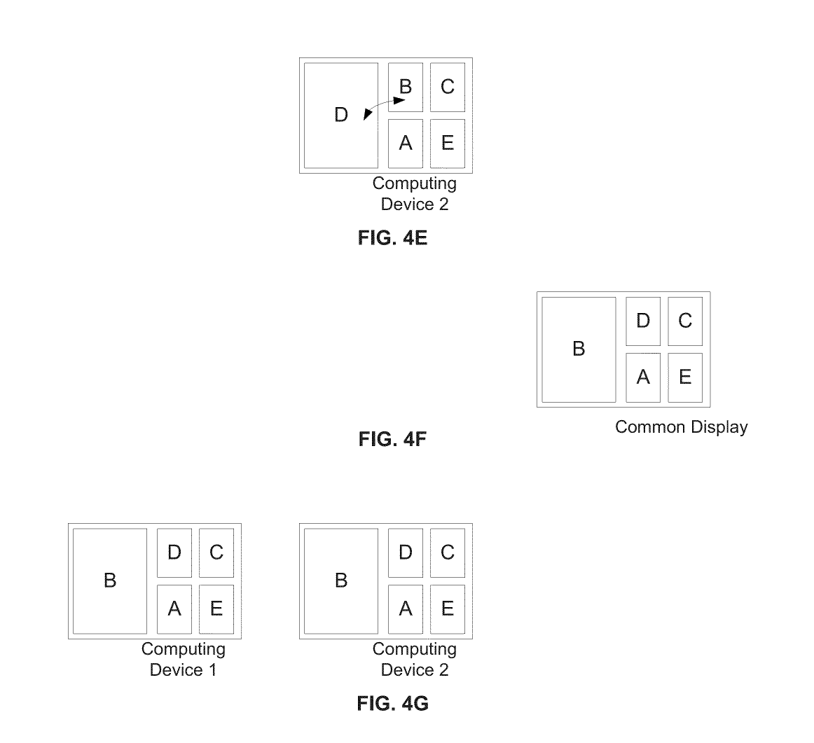

FIGS. 4A-G illustrate a series of block diagrams with content layout illustrated on at least two computing devices and a common display, according to one example. The common display may be connected to the video output of another computing device and viewable by an audience during a presentation or by a team in a conference room. As described earlier, with reference to FIG. 1A, the computing devices may communicate with each other using a set of interconnections 130. The computing device connected to the common display may be configured to detect for content changes from other computing devices, such as computing devices 1 and 2. In addition, the computing device connected to the common display may include instructions for implementing a layout solver that manages the location, size, and scale of each piece of content displayed on the common display and the other computing devices.

Referring to FIG. 4A, the common display may illustrate content from the computing devices or other computing devices connected to the same network as the computing device connected to the common display. The computing devices may be any number of computing devices, such as a desktop workstation, laptop, tablet, or smartphone. As an example, the computing device 1 is a tablet, able to view the content layout via a web-based API, and computing device 2 is a laptop.

Referring to FIG. 4B, the user of computing device 1 swaps content A with content D by dragging and dropping content A onto content D. While content A is dragged onto content D, the content layout of the common display and computing device 2 may not be affected until content A is dropped onto content D (e.g., by the user of computing device 1 completing the action by removing the stylus or finger from the touchscreen device). Upon dropping content A onto content D, computing device 1 may issue a command reflecting the content change.

Referring to FIG. 4C, the computing device connected to the common display generates a content layout responsive to the content change via the layout solver. The layout solver is used to generate the content layout by ensuring the geometric relationships of the content are retained and by resizing the elements (e.g., content A-E) so that no elements overlap or are moved off the display of any computing device or the common display. In an effort to retain the geometric relationships, after content A is swapped with content D, the layout model is updated so that content A replaces the original position of content D and content D replaces the original position of content A. After the layout model has been updated, content B remains above content A and to the right of content D. As a result of retaining the geometric relationships, a user avoids having to remap the positioning of content.

If the aspect ratio of contents A and D are the same, as illustrated, only contents A and D may be resized. However, if the aspect ratios of contents A and D are different, additional elements (e.g., content A-E) may have to be resized, an example of which is illustrated in FIGS. 3A-C. Referring to FIG. 4D, the computing devices display the updated content layout which reflects the content change made by the user of computing device 1.

Referring to FIG. 4E, the user of computing device 2 swaps content D with content B by dragging and dropping content D onto content B. Upon dropping content D onto content B, computing device 2 may issue a command reflecting the content change. Referring to FIG. 4F, the computing device connected to the common display generates a content layout responsive to the content change. Referring to FIG. 4G, the computing devices display the updated content layout which reflects the content change made by the user of computing device 2.

FIG. 5 is a block diagram 500 of a non-transitory machine-readable storage medium encoded with instructions for updating content layout of a display, according to one example. FIG. 5 includes, for example, a processor 510 and a machine-readable storage medium 520 including instructions 522 and 524 for updating the content layout of the display. Processor 510 and machine-readable storage medium 520 may be included in a computing device 502 associated with the display. Referring back to FIG. 1A, the computing device 502 may be the computing device 120 connected to the display 112, or any of the other computing devices connected to the network via interconnections 130.

Processor 510 may be a microprocessor, a semiconductor-based microprocessor, other hardware devices or processing elements suitable for retrieval and execution of instructions stored in machine-readable storage medium 520, or any combination thereof. Processor 510 may fetch, decode, and execute instructions stored in machine-readable storage medium 520 to implement the functionality described in detail below. As an alternative or in addition to retrieving and executing instructions, processor 510 may include at least one integrated circuit (IC), other control logic, other electronic circuit, or any combination thereof that include a number of electronic components for performing the functionality of instructions 522 and 524 stored in machine-readable storage medium 520. Further, processor 510 may include single or multiple cores in a chip, include multiple cores across multiple devices, or any combination thereof.

Machine-readable storage medium 520 may be any non-transitory electronic, magnetic, optical, or other physical storage device that contains or stores executable instructions. Thus, machine-readable storage medium 520 may be, for example, NVRAM, Random Access Memory (RAM), an Electrically Erasable Programmable Read-Only Memory (EEPROM), a storage drive, a Compact Disc Read Only Memory (CD-ROM), and the like. Further, machine-readable storage medium 520 can be computer-readable as well as non-transitory. As described in detail below, machine-readable storage medium 520 may be encoded with a series of executable instructions for updating content layout of a display associated with the computing device 502, for example.

Machine-readable storage medium 520 may include content change receiving instructions 522, which may receive a content change to alter one or more items displayed on the computing device 502. The computing device 502 may listen for commands from other computing devices on the same network as the computing device 502.

Machine-readable storage medium 520 may include layout solver instructions 524, which generates a content layout responsive to the content change. As described above, the layout solver instructions 524 include instructions 526 for ensuring the geometric relationships of the content are retained. By ensuring that the relative positioning of the elements remains the same when the content layout is generated, a user viewing the display of their computing device avoids having to remap where all the elements have been moved after a content change.

Moreover, the layout solver instructions 524 include resizing instructions 528 for resizing the items displayed on the computing device 502 so that no items overlap or are moved off the display. Further, layout solver instructions 524 include instructions for displaying the content layout on the computing device.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

Those skilled in the art would further appreciate that the various illustrative modules and steps described in connection with the examples disclosed herein may be implemented as electronic hardware, computer software, or combination of both. For example, the steps of FIG. 2 may be implemented using software modules, hardware modules or components, or a combination of software and hardware modules or components. Thus, in one example, one or more of the steps of FIG. 2 may comprise hardware modules or components. In another example, one or more of the steps of FIG. 2 may comprise software code stored on a computer readable storage medium, which is executable by a processor.

To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. Those skilled in the art may implement the described functionality in varying ways for each particular application, but such implementation decisions should not be interpreted as causing a departure from the scope of the present disclosure.

What is claimed is

1. A method performed by a computing device, the method comprising:
receiving a content change to alter one or more items displayed on the computing device;
generating a content layout responsive to the content change, wherein positioning of remaining items displayed on the computing device remains the same with respect to positioning of the one or more items; and
displaying the content layout on the computing device.

2. The method of claim 1, further comprising:
generating another content layout responsive to another content change from another computing device;
displaying the other content layout on the computing device; and
providing the other content layout to the other computing device.

3. The method of claim 1, wherein generating the content layout comprises resizing at least the one or more items displayed on the computing device.

4. The method of claim 3, wherein resizing at least the one or more items comprises:
determining an aspect ratio for each of the one or more items; and
resizing the one or more items by retaining their respective aspect ratios.

5. The method of claim 1, wherein the content change to alter the one or more items displayed on the computing device comprises swapping items displayed on the computing device.

6. The method of claim 1, wherein the items displayed on the computing device represent content from multiple sources.

7. The method of claim 6, wherein the content comprises Web content, ActiveX-based content, images, video, remote desktop logins, and productivity software documents.

8. A computing device comprising:
a display for displaying content from computing devices connected to one another via a network;
a processor; and
a memory storing instructions executable by the processor to:
receive a content change to alter one or more items displayed on the display;
generate a content layout responsive to the content change, wherein positioning of remaining items displayed on the display remains the same with respect to positioning of the one or more items; and
display the content layout on the display.

9. The computing device of claim 8, further comprising instructions executable by the processor to:
generate another content layout responsive to another content change from another computing device;
display the other content layout on the display; and
provide the other content layout to the other computing device.

10. The computing device of claim 8, wherein the instruction to generate the content layout comprises resizing at least the one or more items displayed on the display.

11. The computing device of claim 10, wherein resizing at least the one or more items comprises:
determining an aspect ratio for each of the one or more items; and
resizing the one or more items by retaining their respective aspect ratios.

12. A non-transitory computer-readable storage medium comprising instructions that, when executed by a processor of a computing device, cause the computing device to:
receive a content change to alter one or more items displayed on the computing device;
generate a content layout responsive to the content change, wherein positioning of remaining items displayed on the computing device remains the same with respect to positioning of the one or more items; and
display the content layout on the computing device.

13. The non-transitory computer-readable storage medium of claim 12, further comprising instructions that cause the computing device to:
generate another content layout responsive to another content change from another computing device;
display the other content layout on the computing device; and
provide the other content layout to the other computing device.

14. The non-transitory computer-readable medium of claim 12, wherein the instruction causing the computing device to generate the content layout comprises resizing at least the one or more items displayed on the computing device.

15. The non-transitory computer-readable medium of claim 14, wherein resizing a the one or more items comprises:
determining an aspect ratio for each of the one or more items; and
resizing the one or more items by retaining their respective aspect ratios.
